(19) United States
(12) Patent Application Publication
(10) Pub. No.: US 2025/0279445 A1
(43) Pub. Date: Sep. 4, 2025

(54) FUEL EJECTOR FOR A FUEL CELL

(71) Applicant: Cummins Inc., Columbus, IN (US)

(72) Inventors: Saurahb Kumar Verma, Bengaluru (IN); Deepak J. Patil, Pune (IN); Purva Sainath Rasal, Ratnagiri (IN); Sandip V. Patil, Pune (IN); Amol Jagannath Bobade, Pune (IN); Hiren Mansukhlal Gardhariya, Pune (IN); Santosh Shyam Kulkari, Pune (IN)

(21) Appl. No.: 19/058,569

(22) Filed: Feb. 20, 2025

(30) Foreign Application Priority Data
Mar. 1, 2024 (IN) 202441015323

(51) Int. Cl. H01M 8/04089; H01M 8/04082

(52) U.S. Cl. CPC H01M 8/04089; H01M 8/04201

(57) ABSTRACT

A fuel ejector is disclosed to provide gaseous fuel to a fuel cell. The fuel ejector includes an ejector body having first and second fluid inlets and a mixing volume. A nozzle is removably engaged to the ejector body in axial alignment with the first fluid inlet. The nozzle is axially adjustable in position with shims to position the nozzle inlet at a desired location within the mixing volume. A sleeve may also be selected and positioned in the first inlet to establish a throat diameter.

### CROSS-REFERENCE TO RELATED APPLICATION

The present application claims priority to, and the benefit of the filing date of, India Provisional Application No. 202441015323 filed Mar. 1, 2024, which is incorporated herein by reference.

### FIELD OF THE DISCLOSURE

The present disclosure relates generally to fuel ejectors, and more particularly to a fuel ejector for a fuel cell.

### BACKGROUND

Fuel cells can use hydrogen gas as a fuel source to mix with air to form water and electricity via electrolysis in a fuel cell membrane. The electricity is then used as a main power source to rotate an output shaft in order to, for example, propel a vehicle. Unused hydrogen gas, along with water vapor and nitrogen, from the electrolysis process can be recirculated for re-use in the fuel cell. Such recirculation systems typically employ a venturi device such as a fuel ejector to incorporate the recirculated gases into the main gaseous hydrogen fuel supply. However, such venturi devices must be configured with dimensional parameters that are specific to the application in which the fuel cell is to be used in order to generate the required flow velocities and recirculation ratios. Therefore, there remains a need for the unique apparatuses, systems, and techniques disclosed herein.

### DISCLOSURE OF ILLUSTRATIVE EMBODIMENTS

For the purposes of clearly, concisely and exactly describing illustrative embodiments of the present disclosure, the manner, and process of making and using the same, and to enable the practice, making and use of the same, reference will now be made to certain exemplary embodiments, including those illustrated in the figures, and specific language will be used to describe the same. It shall nevertheless be understood that no limitation of the scope of the invention is thereby created and that the invention includes and protects such alterations, modifications, and further applications of the exemplary embodiments as would occur to one skilled in the art.

### SUMMARY

The present disclosure includes a fuel ejector for providing gaseous fuel to a fuel cell system. The fuel cell system uses hydrogen gas as a fuel source along with air, and includes a fuel cell that uses electrolysis to produce electricity. The electrolysis process results in residuals of nitrogen gas, water vapor, and hydrogen gas. In order to preserve the unused hydrogen gas, these residuals are returned to the fuel ejector for entrainment and recirculation with incoming hydrogen gas fuel and then provided to the fuel cell for further electrolysis and production of electricity.

In an embodiment, the fuel ejector includes an elongated ejector body extending along a longitudinal axis from a first inlet to an outlet end of the ejector body. The ejector body includes a second inlet downstream of the first inlet, and a longitudinally extending fuel passage that defines a mixing volume and fluidly connects the first inlet and the second inlet upstream of the outlet end. The fuel ejector also includes a nozzle removably engaged to the outlet end of the ejector body. The nozzle includes a nozzle inlet positioned within the mixing volume to receive gaseous fuel mixed in the mixing volume. The nozzle further includes a nozzle outlet for outletting the mixed gaseous fuel to the fuel cell. The nozzle is adjustable relative to the ejector body along the longitudinal axis to position the nozzle inlet at a selected location within the mixing volume.

In an embodiment, the fuel ejector includes the elongated ejector body extending along the longitudinal axis from the first inlet to the outlet end of the ejector body. The ejector body includes the second inlet downstream of the first inlet, and the longitudinally extending fuel passage that defines the mixing volume and fluidly connects the first inlet and the second inlet upstream of the outlet end. The fuel ejector includes the nozzle engaged to the outlet end of the ejector body. The nozzle includes the nozzle inlet positioned within the mixing volume to receive gaseous fuel mixed in the mixing volume. The nozzle further includes the nozzle outlet for outletting the mixed gaseous fuel to the fuel cell. The fuel ejector also includes a sleeve removably positioned in the fuel passage upstream of the mixing volume. The sleeve defines a throat diameter of the fuel passage in the ejector body.

This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The description herein makes reference to the accompanying drawings wherein like numerals refer to like parts throughout the several views, and wherein:

FIG. 1 is a simplified schematic diagram of a fuel cell system.

FIG. 2 is a perspective of an example fuel ejector for the fuel cell system of FIG. 1.

FIG. 3 is a longitudinal section view illustrating of the example fuel ejector of FIG. 2.

FIG. 4 is an exploded section view of the fuel ejector of FIG. 2.

FIG. 5 is a longitudinal section view illustrating various dimension parameters of the fuel ejector of FIG. 2.

FIG. 6 is an enlarged detail view of a portion of the fuel ejector of FIG. 5.

### DETAILED DESCRIPTION OF ILLUSTRATIVE EMBODIMENTS

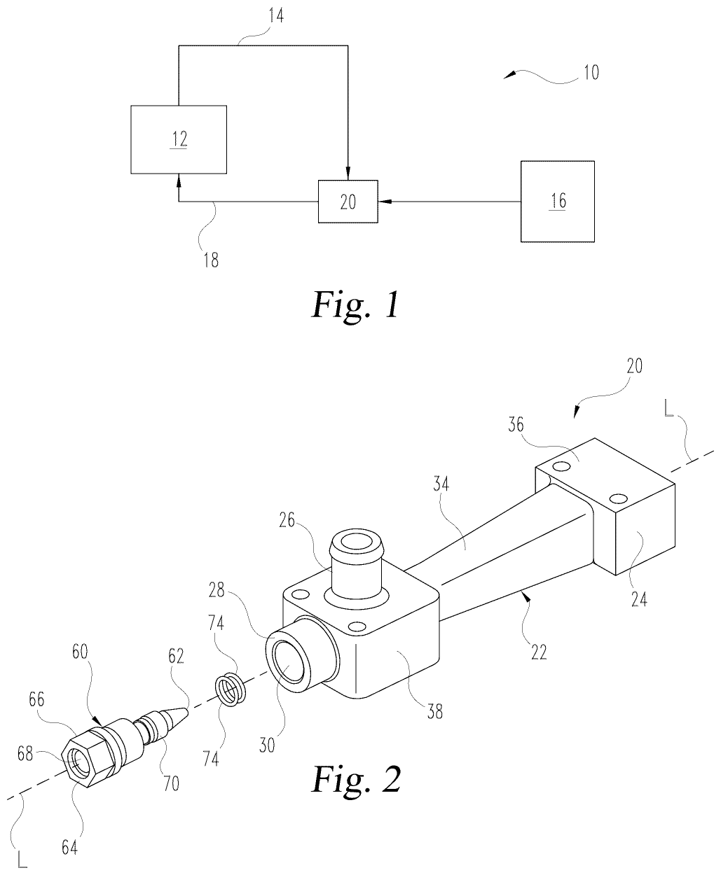

With reference to FIG. 1, there is illustrated a simplified fuel cell system 10 including a fuel ejector 20 and a fuel cell 12. Fuel cell 12 generates power by using air and hydrogen for electrolysis in one or more membranes to generate electricity. Residual hydrogen gas along with nitrogen and water vapor from fuel cell 12 are recycled in a recycle loop 14 connected to fuel ejector 20. Fuel cell system 10 also includes a hydrogen source 16 connected to fuel ejector 20 to provide pressurized hydrogen gas. Fuel ejector 20 entrains the two incoming gaseous flows and provides the mixture to a fuel supply 18 connecting fuel ejector 20 and fuel cell 12. Further details of fuel ejector 20 are provided with reference to FIGS. 2-6.

In an embodiment, fuel ejector 20 provides gaseous fuel to fuel cell 12. Fuel ejector 20 includes an elongated ejector body 22 extending along a longitudinal axis L from a first inlet 24 to an outlet end 28 of ejector body 22. Ejector body 22 includes a second inlet 26 downstream of first inlet 24 and a longitudinally extending fuel passage 30 that defines a mixing volume 32 and fluidly connects first inlet 24 and second inlet 26 upstream of outlet end 28. Fuel ejector 20 also includes a nozzle 60 removably engaged to outlet end 28 of ejector body 22. Nozzle 60 includes a nozzle inlet 62 positioned within mixing volume 32 to receive gaseous fuel mixed in mixing volume 32. Nozzle 60 further includes a nozzle outlet 64 for outletting the mixed gaseous fuel to fuel cell 12. Nozzle 60 is adjustable relative to ejector body 22 along longitudinal axis L to position nozzle inlet 62 at a selected location within mixing volume 32.

In an embodiment, fuel ejector 20 includes elongated ejector body 22 extending along longitudinal axis L from first inlet 24 to outlet end 28 of ejector body 22. Ejector body 22 includes second inlet 26 downstream of first inlet 24 and longitudinally extending fuel passage 30 that defines mixing volume 32 and fluidly connects first inlet 24 and second inlet 26 upstream of outlet end 28. Fuel ejector 20 includes nozzle 60 engaged to outlet end 28 of ejector body 22. Nozzle 60 includes nozzle inlet 62 positioned within mixing volume 32 to receive gaseous fuel mixed in mixing volume 32. Nozzle 60 further includes nozzle outlet 64 for outletting the mixed gaseous fuel to fuel cell 12. Fuel ejector 20 also includes a sleeve 90 removably positioned in fuel passage 30 upstream of mixing volume 32. Sleeve 90 defines a throat diameter Dt of fuel passage 30 in ejector body 22.

Referring to FIG. 2, ejector 20 includes ejector body 22 with first inlet 24, second inlet 26, and outlet end 28. First inlet 24 and outlet end 28 are aligned along longitudinal axis L, body 22 is elongated along longitudinal axis L, and second inlet 26 is transverse to longitudinal axis L. In an embodiment, second inlet 26 is perpendicular to longitudinal axis L, but non-orthogonal orientations are also contemplated and not precluded.

In the illustrated embodiment, ejector body 22 includes a tapered portion 34 connecting block shaped inlet portion 36 and block shaped mixing portion 38. Inlet portion 36 and mixing portion 38 may include holes or other features to facilitate mounting of fuel ejector 20 in fuel cell system 10. Inlet portion 36 and mixing portion 38 may also include other shapes and configurations, such as cylindrical shapes, spherical shapes, conical shapes, irregular shapes, etc.

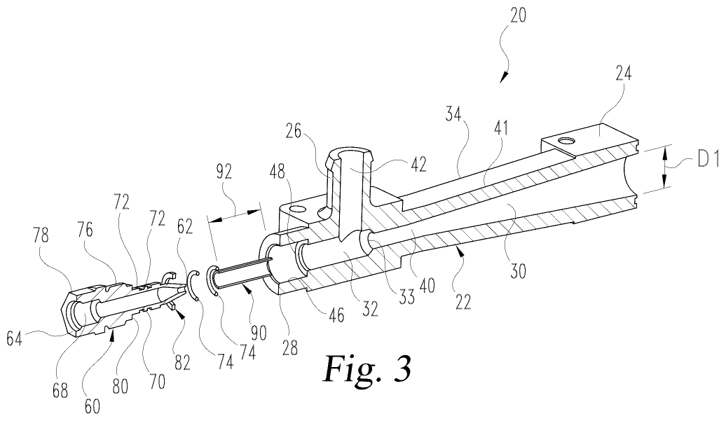

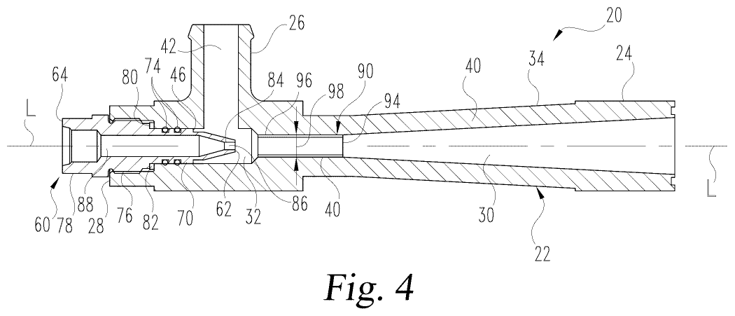

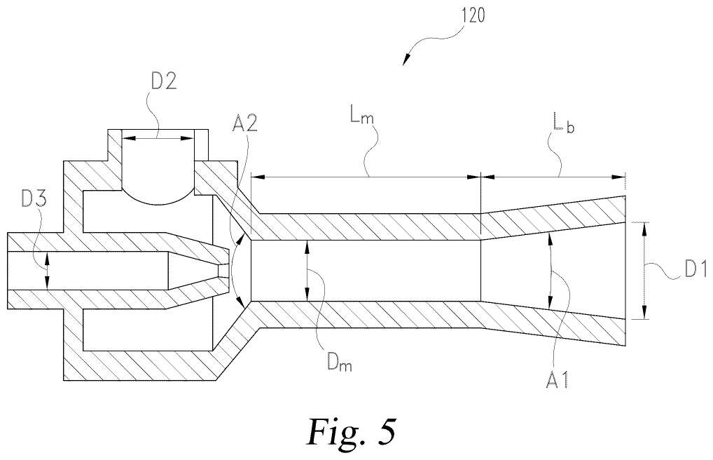

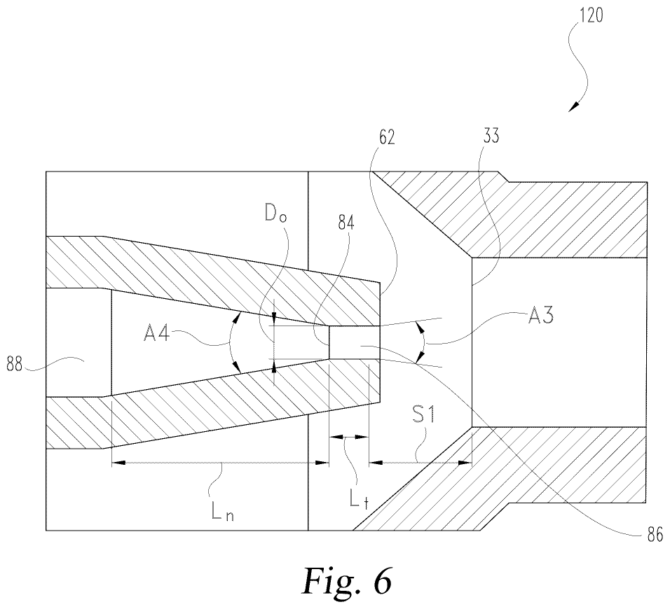

Referring further to FIGS. 3-4, a longitudinal section view and exploded section view of fuel ejector 20 are provided. Various dimensional parameters of ejector body 22, nozzle 60, and sleeve 90 are shown on a fuel ejector template 120 in FIGS. 5-6 for ease of reference.

Fuel passage 30 has a first inlet diameter D1 at or near first inlet 24. Fuel passage 30 also includes a tapered diffuser portion 41 having a diffuser length Lb. Tapered diffuser portion 41 extends from first inlet diameter D1 and is tapered at an inlet angle A1 to a throat region 40 of fuel passage 30. Throat region 40 extends from diffuser portion 40 to mixing volume 32. Throat region 40 provides a constant throat diameter Dm along a throat length Lm upstream of mixing volume 32. Fuel passage 30 widens at a throat outlet angle A2 into mixing volume 32.

Sleeve 90 is positionable in throat region 40 and includes an inner diameter 98 that provides a desired throat diameter Dm when sleeve 90 is positioned in fuel passage 30 along throat region 40. Sleeve 90 includes a sleeve length 92 between opposite sleeve ends 94, 96. In an embodiment, sleeve length 92 corresponds to throat length Lm. In an embodiment, sleeve 90 is selected from a plurality of sleeves 90 having various inner diameters in order to customize throat diameter Dm of fuel ejector 20. In other embodiments, sleeve 90 is omitted because throat region 40 of fuel passage 30 provides the desired throat diameter Dm.

Second inlet 26 includes a tubular configuration defining second inlet passage 42. Second inlet passage 42 includes a second inlet diameter D2 configured to admit the recirculated hydrogen gas, nitrogen, and water vapor from fuel cell 12. Second inlet passage 42 opens into mixing volume 32 so that the recycled hydrogen, nitrogen and water vapor from fuel cell 12 mixes with hydrogen fuel provided by fuel passage 30 from fuel source 16 connected to first inlet 24.

Nozzle 60 includes a nozzle body 66 extending from nozzle inlet 62 to nozzle outlet 64. Nozzle body 66 defines a nozzle passage 68 extending from nozzle inlet 62 to nozzle outlet 64. Nozzle body 66 includes a sealing portion 70 with circumferential grooves 72. Circumferential grooves 72 receive respective ones of seals 74. In an embodiment, seals 74 are ring-shaped elastomer seals that fit within corresponding ones of the grooves 72. Seals 74 contact an inner wall surface 46 of ejector body 22 to prevent gaseous fuel flow between an outer surface of nozzle body 66 and ejector body 22. In the illustrated embodiment, two seals 74 are provided. Other embodiments contemplate a single seal 74, or three or more seals 74.

Nozzle body 66 also includes a threaded portion 76 between sealing portion 70 and an outer radially extending flange 78. Threaded portion 76 can threadingly engage internal threads along ejector body 22 adjacent outlet end 28. Threaded portion 76 forms an axially facing lip 80 adjacent to and downstream of sealing portion 70. Outer flange 78 is located outside of ejector body 22, and is positioned adjacent to or in axial engagement with outlet end 28 of ejector body 22.

Ejector body 22 includes an internal radially extending surface 48 facing outlet end 28. A shim 82 is positioned between radially extending surface 48 and axially facing lip 80 to adjust or set a longitudinal position of nozzle inlet 62 in mixing volume 32. In particular, the axial location of nozzle inlet 62 can be controlled to provide the desired performance characteristic by using one or more shims 82 between nozzle 60 and ejector body 22. Fine tuning and axial adjustment of nozzle 60 along longitudinal axis L is thus possible with shims 82 while leakage is prevented with seals 74.

Nozzle 60, ejector body 22, sleeve 90, and/or shims 82 can provide a modular assembly or sub-assembly of fuel ejector 20. For example, the final components of fuel ejector 20 can be selected from a plurality of nozzles 60, a plurality of ejector bodies 22, a plurality of sleeves 90, and/or a plurality of shims 82 having differing dimensional parameters. The selected nozzle 60, ejector body 22, sleeve 90, and/or shim(s) 82 are assembled to provide fuel ejector 20 with the desired fuel flow and mixing characteristics for a particular fuel cell application. For example, a fuel cell 12 with a first kilowatt output will require a fuel ejector 20 with different configuration and/or dimensional parameters than a fuel ejector 20 for a fuel cell with a second, higher kilowatt output due to differing flow rate and/or recirculation ratio requirements.

For example, an ejector body 22 can be selected that provides a desired throat length Lm, tapered diffuser length Lb, and/or mixing chamber 32 length. The throat length Lm and/or tapered diffuser length Lb provide differing suction, entrainment, and/or recirculation ratio capabilities. Different mixing chamber lengths can provide different mixing volumes and interfaces with nozzle 60.

If the throat diameter Dm of the selected ejector body 22 is too large, a sleeve 90 having the desired throat diameter Dm can be selected and placed into fuel passage 30 along the throat region 40. The sleeve 90 may or may not have a length 92 that corresponds to the throat length Lm of the selected ejector body 22.

In addition, or alternatively, a nozzle 60 and/or shim(s) 82 can be selected that provide the desired nozzle performance characteristics. The length of nozzle 60 from lip 80 to nozzle inlet 62 and/or shim(s) 82 can be used to control the spacing S1 of nozzle inlet 62 from the downstream end 33 of mixing chamber 32.

In addition, nozzle 60 includes an orifice 84 adjacent to nozzle inlet 62. Nozzle inlet 62 defines an inlet opening 86 into orifice 84 that is tapered in a downstream direction at angle A3 to orifice 84. Orifice 84 has a constant orifice diameter Do along orifice length Lt. Nozzle 60 then expands at angle A4 along an expansion length Ln to an outlet region 88 of nozzle passage 68. Outlet region 88 has a constant diameter D3 up to outer flange 78.

Nozzle 60 can be selected from a plurality of nozzles 60 having different dimensions for these parameters. Different sizes/configurations for orifice 84 provide different flow velocities, which effects suction and entrainment capabilities. The selected nozzle 60 can then be engaged to the selected ejector body 22. A sleeve 90 and/or one or more shims 82 may also be employed to provide the final desired dimensional parameters to the assembled fuel ejector 20.

The modularity and interchangeability of the various components of fuel ejector 20 also allows for different material to be readily used for different components of fuel ejector 20, such as the ejector body 22, nozzle 60, and/or sleeve 90. Example materials which can be used for any one or more, or all, of the components in an assembled fuel ejector 20 include, for example, stainless steel, aluminum, and/or plastic. Other materials are also contemplated and not precluded.

Various aspects of the present disclosure are contemplated. According to one aspect, a fuel ejector for providing gaseous fuel to a fuel cell is provided. The fuel ejector includes an elongated ejector body extending along a longitudinal axis from a first inlet to an outlet end of the ejector body. The ejector body includes a second inlet downstream of the first inlet and a longitudinally extending fuel passage that defines a mixing volume fluidly connecting the first inlet and the second inlet upstream of the outlet end. The fuel ejector also includes a nozzle removably engaged to the outlet end of the ejector body. The nozzle includes a nozzle inlet positioned within the mixing volume to receive gaseous fuel mixed in the mixing volume. The nozzle further includes a nozzle outlet for outletting the mixed gaseous fuel to the fuel cell. The nozzle is adjustable relative to the ejector body along the longitudinal axis to position the nozzle inlet at a selected location within the mixing volume.

In an embodiment, a sleeve is removably positioned in the fuel passage upstream of the mixing volume. The sleeve defines a throat diameter of the fuel passage in the ejector body. In a further embodiment, the sleeve is selected from a plurality of sleeves to provide the throat diameter based on a desired power output of the fuel cell.

In a further embodiment, the ejector body defines a throat length along a portion the fuel passage upstream of the mixing volume, and the sleeve defines a sleeve length that corresponds to the throat length. In yet a further embodiment, the fuel passage is tapered toward the throat diameter upstream of the portion of the fuel passage that defines the throat length.

In an embodiment, at least one shim is positioned between the ejector body and the nozzle to adjust the position of the nozzle inlet along the longitudinal axis.

In a further embodiment, the ejector body defines a radially extending surface facing the outlet end of the ejector body, the nozzle includes a radially extending lip, and the shim is positioned between the lip and the radially extending surface. In yet a further embodiment, the nozzle includes an outer radially extending flange portion adjacent to or in axial engagement with the outlet end of the ejector body.

In an embodiment, at least one seal is positioned between the nozzle and the ejector body. The at least one seal prevents gaseous fuel flow between the nozzle and the ejector body. In a further embodiment, the at least one seal includes at least two seals.

In an embodiment, the nozzle is threadingly engaged to the outlet end of the ejector body. In an embodiment, the mixing volume extends from a first location upstream of the second inlet to a second location downstream of the nozzle inlet.

According to another aspect of the present disclosure, a fuel ejector for providing gaseous fuel to a fuel cell is provided. The fuel ejector includes an elongated ejector body extending along a longitudinal axis from a first inlet to an outlet end of the ejector body. The ejector body includes a second inlet downstream of the first inlet and a longitudinally extending fuel passage that defines a mixing volume fluidly connecting the first inlet and the second inlet upstream of the outlet end. The fuel ejector includes a nozzle engaged to the outlet end of the ejector body. The nozzle includes a nozzle inlet positioned within the mixing volume to receive gaseous fuel mixed in the mixing volume. The nozzle further includes a nozzle outlet for outletting the mixed gaseous fuel to the fuel cell. The fuel ejector includes a sleeve removably positioned in the fuel passage upstream of the mixing volume. The sleeve defines a throat diameter of the fuel passage in the ejector body.

In an embodiment, the nozzle is adjustable relative to the ejector body along the longitudinal axis to position the nozzle inlet at a desired location within the mixing volume. In a further embodiment, at least one shim is positioned between the ejector body and the nozzle to adjust the position of the nozzle inlet along the longitudinal axis.

In yet a further embodiment, the at least one shim is selected from a plurality of shims that provides a desired position of the nozzle inlet along the longitudinal axis. In yet a further embodiment, at least one seal is positioned between the nozzle and the ejector body. The at least one seal prevents gaseous fuel flow between the nozzle and the ejector body.

In an embodiment, the sleeve is selected from a plurality of sleeves to provide the throat diameter that is based on a desired power output of the fuel cell. In an embodiment, the sleeve is downstream of the first inlet and upstream of the second inlet. In an embodiment, the second inlet is perpendicular to the fuel passage.

While illustrative embodiments of the disclosure have been illustrated and described in detail in the drawings and foregoing description, the same is to be considered as illustrative and not restrictive in character, it being understood that only certain exemplary embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A fuel ejector for providing gaseous fuel to a fuel cell, the fuel ejector comprising:
an elongated ejector body extending along a longitudinal axis from a first inlet to an outlet end of the ejector body, the ejector body including a second inlet downstream of the first inlet and a longitudinally extending fuel passage that defines a mixing volume fluidly connecting the first inlet and the second inlet upstream of the outlet end; and
a nozzle removably engaged to the outlet end of the ejector body, the nozzle including a nozzle inlet positioned within the mixing volume to receive gaseous fuel mixed in the mixing volume, the nozzle further including a nozzle outlet for outletting the mixed gaseous fuel to the fuel cell, the nozzle being adjustable relative to the ejector body along the longitudinal axis to position the nozzle inlet at a selected location within the mixing volume.

2. The fuel ejector of claim 1, comprising a sleeve removably positioned in the fuel passage upstream of the mixing volume, wherein the sleeve defines a throat diameter of the fuel passage in the ejector body.

3. The fuel ejector of claim 2, wherein the sleeve is selected from a plurality of sleeves to provide the throat diameter based on a desired power output of the fuel cell.

4. The fuel ejector of claim 2, wherein:
the ejector body defines a throat length along a portion the fuel passage upstream of the mixing volume; and
the sleeve defines a sleeve length that corresponds to the throat length.

5. The fuel ejector of claim 4, wherein the fuel passage is tapered toward the throat diameter upstream of the portion of the fuel passage that defines the throat length.

6. The fuel ejector of claim 1, comprising at least one shim between the ejector body and the nozzle to adjust the position of the nozzle inlet along the longitudinal axis.

7. The fuel ejector of claim 6, wherein:
the ejector body defines a radially extending surface facing the outlet end of the ejector body;
the nozzle includes a radially extending lip; and
the shim is positioned between the lip and the radially extending surface.

8. The fuel ejector of claim 7, wherein the nozzle includes an outer radially extending flange portion adjacent to or in axial engagement with the outlet end of the ejector body.

9. The fuel ejector of claim 1, comprising at least one seal between the nozzle and the ejector body, the at least one seal preventing gaseous fuel flow between the nozzle and the ejector body.

10. The fuel ejector of claim 9, wherein the at least one seal includes at least two seals.

11. The fuel ejector of claim 1, wherein the nozzle is threadingly engaged to the outlet end of the ejector body.

12. The fuel ejector of claim 1, wherein the mixing volume extends from a first location upstream of the second inlet to a second location downstream of the nozzle inlet.

13. A fuel ejector for providing gaseous fuel to a fuel cell, the fuel ejector comprising:
an elongated ejector body extending along a longitudinal axis from a first inlet to an outlet end of the ejector body, the ejector body including a second inlet downstream of the first inlet and a longitudinally extending fuel passage that defines a mixing volume fluidly connecting the first inlet and the second inlet upstream of the outlet end;
a nozzle engaged to the outlet end of the ejector body, the nozzle including a nozzle inlet positioned within the mixing volume to receive gaseous fuel mixed in the mixing volume, the nozzle further including a nozzle outlet for outletting the mixed gaseous fuel to the fuel cell; and
a sleeve removably positioned in the fuel passage upstream of the mixing volume, wherein the sleeve defines a throat diameter of the fuel passage in the ejector body.

14. The fuel ejector of claim 13, wherein the nozzle is adjustable relative to the ejector body along the longitudinal axis to position the nozzle inlet at a desired location within the mixing volume.

15. The fuel ejector of claim 14, comprising at least one shim between the ejector body and the nozzle to adjust the position of the nozzle inlet along the longitudinal axis.

16. The fuel ejector of claim 15, wherein the at least one shim is selected from a plurality of shims that provides a desired position of the nozzle inlet along the longitudinal axis.

17. The fuel ejector of claim 15, comprising at least one seal between the nozzle and the ejector body, the at least one seal preventing gaseous fuel flow between the nozzle and the ejector body.

18. The fuel ejector of claim 13, wherein the sleeve is selected from a plurality of sleeves to provide the throat diameter that is based on a desired power output of the fuel cell.

19. The fuel ejector of claim 13, wherein the sleeve is downstream of the first inlet and upstream of the second inlet.

20. The fuel ejector of claim 13, wherein the second inlet is perpendicular to the fuel passage.
